(19) United States
(12) Patent Application Publication
(10) Pub. No.: US 2026/0284599 A1
(43) Pub. Date: Sep. 24, 2026

(54) A FILTRATION MODULE AND A METHOD OF INSTALLING A FILTRATION MODULE

(71) Applicant: Alfa Laval Corporate AB, LUND (SE)

(72) Inventors: Henrik LARSEN, NÆSTVED (DK); Boye KRISTENSEN, TORRIG L (DK)

(73) Assignee: Alfa Laval Corporate AB, LUND (SE)

(21) Appl. No.: 19/476,410

(22) PCT Filed: Apr. 18, 2024
(86) PCT No.: PCT/EP2024/060585

§ 371 Date: Oct. 17, 2025

(30) Foreign Application Priority Data
Apr. 19, 2023 (EP) 23168634.6
Apr. 19, 2023 (EP) 23168635.3

(51) Int. Cl. B01D 63/10; B01D 65/00

(52) U.S. Cl. CPC B01D 63/103; B01D 65/003; B01D 2313/14; B01D 2313/201

(57) ABSTRACT

The present invention relates to a filtration module. The module being substantially cylindrical and extending in a longitudinal direction. The module comprising a permeate tube defining a plurality of perforations and a membrane filtration element being spirally wound around the permeate tube. The membrane filtration element being in fluid communication with at least one of the perforations. The module further comprising a wrap surrounding the wound membrane filtration element and a flap for being positioned onto and covering at least a part of the outer surface of the wrap, the wrap and the flap both being made of a fluid permeable polymeric grid material having ribs extending in the circumferential direction.

The present invention relates to a filtration module and a method of installing a filtration module into a non-permeable filter housing of a sanitary filtration plant.

### INTRODUCTION

Sanitary filtration plants using spiral wound membranes can be used for reverse osmosis, nanofiltration, ultrafiltration and microfiltration to efficiently recover, purify, fractionate or concentrate products in industries such as food, beverage, dairy, biotech/biobased chemicals and pharma.

Sanitary filtration plants of the above type are known to use filtration modules comprising membrane filtration elements spirally wound on permeate tubes. In a typical filtration plant the filtration modules will be disposed within the non-permeable filter housing of the sanitary filtration plant. Pumps will be used to pump a fluid feed thru the filter module which is disposed in the housing.

The fluid feed enters at one end of the filter housing and travels thru the filtration module via wound feed spacers positioned parallel to and between wound membrane layers of the membrane filtration elements. Separation occurs at the membrane-fluid interface, in with part of the fluid, called the permeate, passing thru the membrane layer while the rest of the fluid feed, called retentate, remains on the opposite side of the membrane as more highly concentrated feed. The permeate stream travels in an inwardly spiralling radial direction until it passes thru the perforations of the permeate tube for recovery from one or both ends of the permeate tube.

For use in this type of filter plant housings the filtration module comprises a wrap which is enclosing the membrane filtration elements to keep the spirally wound membrane filtration elements from unwinding an to keep a uniform diameter of the filtration module. However, due to manufacturing tolerances there will usually be an annular gap between the outer perimeter of the module and the inner perimeter of the filter housing in which the fluid feed may flow and bypass the filtration module.

It is important that the filter modules fit snugly for them to function properly. A loose-fitting module put into operation will allow much of the flow will go around the filter module resulting in lower fluxes thru the filtration module, more rapid fouling, lower permeate flow and higher cleaning costs. The flow bypassing the filtration module by flowing in the gap will essentially constitute a loss and will require the pumps to pump an unnecessary amount of fluid thru the filter. Also, the filtration elements may loosen during operation which may result in buckling or wrinkling of the membrane, which in turn may result in damage to the membrane and possibly leakage.

The object of the present invention is therefore to provide technologies which allow the filtration module to fit snugly into the housing despite manufacturing tolerances.

US 2013/0161258 A1 relates to a brine seal for a spiral wound membrane element. The brine seal has an elongate body with a flexible wing. The brine seal is wrapped around the spiral membrane element with a space between each turn of the brine seal.

JP 2011/092905A relates to a membrane with protrusions.

U.S. Pat. No. 8,668,828 relates to spiral wound membrane cartridge having a thin tubular shell having a textured exterior surface to allow controlled bypass flow of liquid feed between a pressure vessel interior and a textured exterior surface of the shell.

U.S. Pat. No. 5,985,146 relates to a fluid separation device having a rigid, nonporous shell and a spiral wound membrane filtration element positioned inside the rigid, nonporous shell. A threaded groove running around the circumference and down the length of the exterior surface of the shell.

U.S. Pat. No. 4,064,052 relates to a spirally wound membrane having a lip seal between the module and the containment tube.

US 2009/0200237 A1 relates to a filter media having a flow control strip circumferentially surrounding the media at one end. The strip preferably is an open mesh material that cooperates with an overlapping portion of an open mesh net that surrounds the filter media. The strip creates a compressible area that restricts bypass flow while allowing for easy installation and removal of the membrane module.

U.S. Pat. No. 4,839,037 relates to a spirally wound filter cartridge including a centrally disposed tube and a sheet of filtration material spirally wound around the tube.

U.S. Pat. No. 5,128,037 relates to a spiral wound filtration cartridge having an end plate for controlling fluid flow within the space between the outer cylinder and the housing.

U.S. Pat. No. 4,902,417 relates to a spiral wound membrane cartridge having a feed layer having a plurality of parallel ribs.

U.S. Pat. No. 4,548,714 relates to a membrane cartridge for insertion into a pressure resistant container. The cartridge has a porous grid material having an extension which is of sufficient length to encompass the circumference of the cartridge when the cartridge is positioned inside the container.

U.S. Pat. No. 5,073,263 relates to an ultrafiltration module comprising a permeate collector tube, one or more membrane leaves wound around the tube, an outer wrap screen circumscribing the wound leaves and a bypass screen also of open mesh configuration is wrapped around the outer wrap.

U.S. Pat. No. 3,063,888 relates to a filter tube having a strip of foraminous material.

U.S. Pat. No. 5,460,720 relates to a fluid separation device, utilizing tubular or flat sheet membrane materials, bounded on the membrane side of the sheet by a sheet of a porous feed spacer material.

WO 2022/187472 A1 relates to a by-pass control sleeve has circumferential protrusions along its outer surface.

### SUMMARY OF THE INVENTION

The above object is realized according to a first aspect of the present invention by a filtration module for filtrating a fluid feed into a retentate portion and a permeate portion, the module being substantially cylindrical and extending in a longitudinal direction between a first end and a second end, the first end and the second end being substantially circular, the module comprising:
a permeate tube extending substantially between the first end and the second end, the permeate tube defining a plurality of perforations,
a membrane filtration element extending substantially between the first end and the second end and being spirally wound around the permeate tube, the membrane filtration element being in fluid communication with at least one of the perforations,
a wrap surrounding the wound membrane filtration element and extending substantially between the first end and the second end, the wrap defining an outer surface, the outer surface defining a circumferential direction being substantially perpendicular to the longitudinal direction, and
a flap for being positioned onto and covering at least a part of the outer surface of the wrap, the wrap and the flap both being made of a fluid permeable polymeric grid material having ribs extending in the circumferential direction.

The flap and the wrap are both made of a fluid permeable polymeric grid material to allow feed fluid to pass thru. The wrap is substantially covering the complete cylindrical surface of the wound membrane filtration element, but not the circular ends. It is being applied as a sleeve or jacket in one or more layers in a snug fit, and may comprise multiple layers. The flap and the wrap have ribs extending in the circumferential direction to increase the flow resistance of the fluid feed flowing in the longitudinal direction. The flap is provided to compensate for manufacturing tolerances and may be cut into suitable circumferential length such that the outer perimeter of the filtration module matches the inner perimeter of the filter housing. In this way a snug fit between the filtration module and the filter housing is achieved

The flap is substantially loosely fitted onto the outer surface of the wrap to be able to allow it to be adapted to the interior space of the filter housing. The flap is provided with ribs to cooperate with the ribs of the wrap to accommodate differences between the outer perimeter of the filtration module and the inner diameter of the housing and for the flap to be kept in plate during insertion of the module into the housing without wrinkling or buckling.

According to a further embodiment of the first aspect, the flap tapers in the longitudinal direction from the second end to the first end.

A very quick and efficient installation of the filter module into the housing of the filtration plant can be achieved by using a tapered flap. The tapered flap will allow the circumferential perimeter of the filtration module to increase in the longitudinal direction from the first end to the second end. By inserting the first end of the filtration module into the opening of the filter housing and sliding the filtration module into the inner space of the filter housing until the perimeter of the filtration module exceeds the perimeter of the opening, a direct indication is given of the width of the flap needed to be cut away. The filtration module is thereby inserted into the filter housing until it stops, leaving a remaining part of the filtration module outside the housing

By reducing the circumferential perimeter of the remaining part of the spiral filtration module by cutting the flap at the location where the flap meets the opening it will be possible to insert the remaining part of the spiral filtration module into the housing and achieve a snug fit without any use of trial and error, and without the risk of cutting too much off the flap.

According to a further embodiment of the first aspect, the flap defines a first edge extending in the circumferential direction at the first end, a second edge extending in the circumferential direction at the second end and being longer than the first edge, and a third edge extending between the first edge and the second edge at an angle relative to the longitudinal direction.

Preferably, one longitudinal edge of the flap forms an angle relative to the longitudinal direction of the filtration module to provide the tapering of the flap.

According to a further embodiment of the first aspect, the flap defines a fourth edge extending between the first edge and the second edge opposite the third edge and defining an angle relative to the longitudinal direction.

Both longitudinal edges of the flap may form an angle relative to the longitudinal direction of the filtration module to allow the flap to be cut at two locations.

According to a further embodiment of the first aspect, the ribs of the wrap define a first spacing between themselves and the ribs of the flap define a second spacing between themselves, the first spacing being different than the second spacing.

In this way some ribs of the flap will overlap some ribs of the wrap which provides some flexibility between the flap and the wrap. This may allow the filtration module to adapt to the manufacturing tolerances and help achieving a snug fit between the housing and the filtration module.

According to a further embodiment of the first aspect, the flap is fixated to the wrap by e.g. gluing or welding.

The flap may be provided loose and applied to the outer surface of the wrap just before installation. On the other hand, it may be fixated to the outer surface of the wrap to ensure a correct installation and prevent slipping, buckling or wrinkling of the flap during installation. The flap may be fixated by e.g. gluing or welding, such as spot welding. It may be fixated at one location or multiple locations. It may be fixated along one or more transversal or longitudinal directions. It may be fixated at one or more edges or at the centre.

According to a further embodiment of the first aspect, the ribs of the wrap and the ribs of the flap are facing each other, or alternatively, wherein the ribs of the wrap and the ribs of the flap are facing in the same direction.

In this way any longitudinal movement of the flap relative to the outer surface of the wrap will be prevented. This may prevent slipping, buckling or wrinkling of the flap during installation. Additionally, some ribs of the flap may interact with some ribs of the wrap which provides some flexibility between the flap and the wrap. This may allow the filtration module to adapt to the manufacturing tolerances and help achieving a snug fit between the housing and the filtration module. Alternatively, the ribs of the wrap and the ribs of the flap are facing in the same direction. This may increase turbulence in the gap and thus reduce the crossflow. Preferably, in this latter case, the wrap and the flap are fixated to prevent slipping.

According to a further embodiment of the first aspect, the flap defines a higher flexibility than the wrap and/or the flap defines a higher elasticity than the wrap.

This may allow the filtration module to adapt to the manufacturing tolerances and help achieving a snug fit between the housing and the filtration module.

According to a further embodiment of the first aspect, the membrane filtration element comprises one or more permeate transfer sheets, one or more membrane sheets and one or more feed spacer sheets. The permeate transfer sheets allow the permeate to flow to the perforations or the permeate tube after passing though the membrane sheets. The feed spacer sheets allow the retentate to flow though the filtration module.

According to an embodiment of the first aspect, the filtration module according to any of the preceding claims, wherein the flap extending less than one turn in the circumferential direction along the outer surface, preferably between 20% and 80% of one turn in the circumferential direction along the outer surface, more preferably between 30% and 70% of one turn in the circumferential direction along the outer surface.

The flap must not necessarily cover the complete outer surface of the wrap. Installation will be easier if the flap convers only a part of the outer surface.

According to a further embodiment of the first aspect, the flap has a length in the longitudinal direction being substantially equal or less than the distance between the first end and the second end, preferably between 20% and 80% of the distance between the first end and the second end, more preferably between 30% and 70% of the distance between the first end and the second end.

Preferably, the flap has a length in the longitudinal direction being substantially equal to the length of the wrap.

The above object is realized according to a second aspect of the present invention by a method of installing a filtration module into a non-permeable filter housing, the filter housing defining an opening and an inner space being accessible thru the opening, the opening defining a first perimeter, the method comprising:
providing a filtration module according to the first aspect, the filtration module defining a second perimeter,
inserting the first end of the spiral filtration module into the opening of the housing and
sliding the spiral filtration module into the inner space of the housing until the second perimeter exceeds the first perimeter, thereby leaving a remaining part of the filtration module outside the housing,
reducing the second perimeter of the remaining part of the spiral filtration module by cutting the flap at the location where the flap meets the opening, and
inserting the remaining part of the spiral filtration module into the housing.

Preferably, the above method is used together with any of the embodiments of the first aspect.

According to a further embodiment of the second aspect, the flap is cut in the circumferential direction or in the longitudinal direction. Cutting in the circumferential direction may be easier since it will not be necessary to cut any of the ribs. Cutting in the circumferential direction may be more efficient as it leaves more effective area of the flap.

The above object is realized according to a third aspect of the present invention by a method of installing a filtration module into a non-permeable filter housing, the filter housing defining an opening and an inner space being accessible thru the opening, the opening defining a first perimeter, the method comprising:
providing a filtration module according to the first aspect, the filtration module defining a second perimeter,
inserting the first end of the spiral filtration module into the opening of the housing and
sliding the spiral filtration module into the inner space of the housing,
thereby reducing the second perimeter to match the first perimeter by causing the ribs of the wrap to interfere with the ribs of the flap.

Preferably, the above method is used together with any of the embodiments of the first aspect.

### BRIEF DESCRIPTION OF THE DRAWINGS

FIG. 1A is a view of the permeate tube and the membrane filtration elements before winding.

FIG. 1B is a view of the permeate tube and partially spiralled membrane filtration elements.

FIG. 1C is a view of a wrap surrounding the wound membrane filtration element.

FIG. 1D is a view of the insertion of the filtration module into the filter housing.

FIG. 2 is a view of the filtration module installed into the filter housing.

FIG. 3A is a view of the filtration module including the tapered flap and the wrap.

FIG. 3B is a view of the filtration module with the tapered flap positioned onto the wrap.

FIG. 3C is a view of the insertion of the filtration module into the filter housing.

FIG. 3D is a view of the filtration module partially inserted into the filter housing.

FIG. 3E is a view of the longitudinal cutting of the flap.

FIG. 3F is a view of the circumferential cutting of the flap.

FIG. 3G is a view of the filtration module fully inserted into the filter housing.

FIG. 3H is a view of the filter housing being closed.

FIG. 4A is a view of the filtration module including the separate flap and the wrap.

FIG. 4B is a view of the filtration module including the separate flap positioned on the wrap.

FIG. 5A is a view of the filtration module including the flexible flap positioned on the wrap.

FIG. 5B is a view of the filtration module including the flexible flap positioned on the wrap.

FIG. 5C is a view of the filtration module including the flexible flap inserted into the filter housing.

### DETAILED DESCRIPTION OF THE DRAWINGS

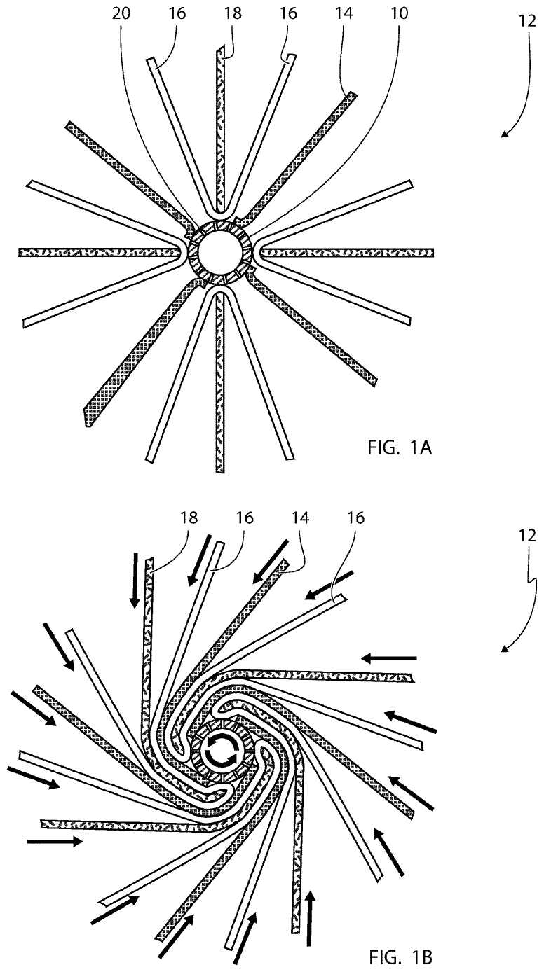

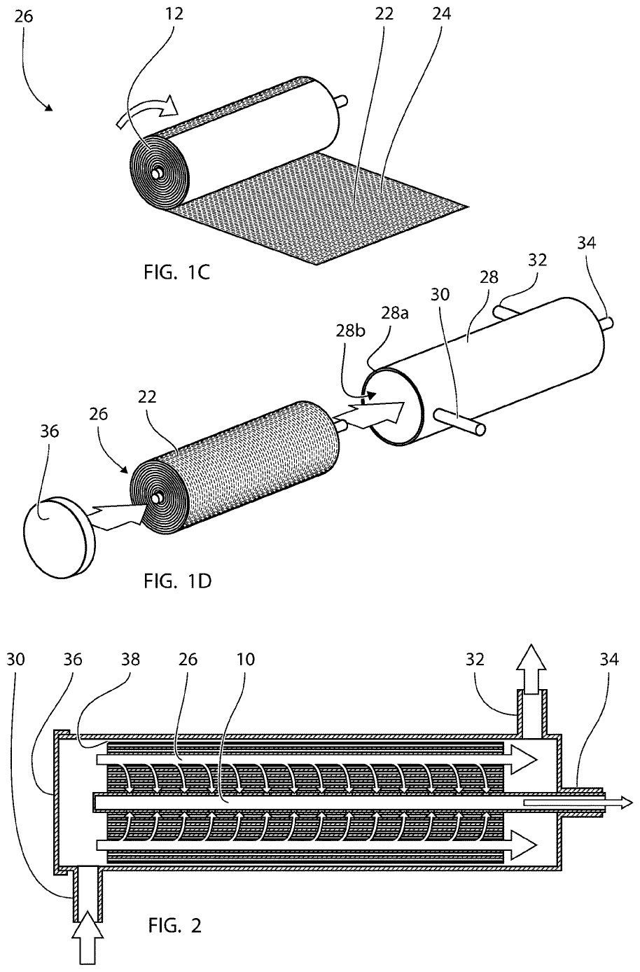

FIG. 1A is a side view of a permeate tube 10 and a plurality of unwound membrane filtration elements 12. Each membrane filtration element 12 comprising a permeate transfer sheet 14, a membrane sheet 16 and a feed spacer sheet 18. The permeate tube 10 comprises a plurality of perforations 20 for the permeate (not shown). The fluid feed (not shown) is intended to flow thru the feed spacer sheet 18 allowing the membrane sheet 16 to separate the fluid feed (not shown) into a permeate (not shown) flowing thru the membrane sheet 16 and a retentate remaining in the feed spacer sheet 18 and flowing thru the membrane filtration element 12. The permeate (not shown) flows into the permeate tube 10 via the perforations 20.

FIG. 1B is a side view of the membrane filtration elements 12, including the permeate transfer sheet 14, the membrane sheet 16 and the feed spacer sheet 18, partially spiralled around the permeate tube 10 as shown by the arrows. Thereby a substantially cylindrical assembly is formed comprising the membrane filtration elements 12 and the permeate tube 10.

FIG. 1C is a perspective view of a filtration module 26 comprising a wrap 22 surrounding the wound membrane filtration elements 12, thereby forming the basic substantially cylindrical filtration module 26. The wrap 22 is made of a fluid permeable polymeric grid material having ribs 24 extending in the circumferential direction of the. The wrap 22 is fluid permeable to allow fluid feed to flow thru. The wrap 22 may be formed by one or more layers forming a sleeve or jacket around the membrane filtration elements 12. The purpose of the wrap 22 is to prevent the membrane filtration elements 12 from unwinding and keep the membrane filtration elements 12 in place during operation to prevent buckling or wrinkling of the membrane filtration elements 12. The ribs 24 extending in the circumferential direction reinforce the wrap 22, prevents slipping between the wrap 22 and the membrane filtration elements 12. The ribs 24 also increase the flow resistance of feed flowing outside the membrane filtration elements 12. The wrap 22 is fixated onto itself by welding or gluing.

FIG. 1D is a perspective view of the insertion of the filtration module 26 into a filter housing 28. The substantially cylindrical filtration module 26 is inserted into the non-permeable filter housing 28 thru an opening 28a. The opening 28a is circular and substantially corresponds to the circumference of the filter module 26. The filter housing 28 has an inner space 28b which substantially corresponds to the outer shape of the filtration module 26. The housing 28 has a feed flow inlet 30 and a feed flow outlet 32 located at opposite ends of the housing 28 and a permeate outlet 34 which is centrally located at one end of the housing 28. The opening 28a of the housing 28 is hermetically closed off by a lid 36.

FIG. 2 is an intersect view of the filtration module 26 installed into the filter housing 28. The fluid feed enters the housing 28 via the feed flow inlet 30 as shown by the arrow and continues thru the filtration module 26 as previously described. The retentate flows out of the housing 28 thru the feed flow outlet 32. The permeate flows out thru the centrally located permeate tube 10 which is in fluid communication with the permeate outlet 34. To take account for manufacturing tolerances of the filtration module 26 and the housing 28 an annular gap 38 will be present in the inner space 28b of the housing 28, between the filtration module 26 and the housing 28. The gap 38 constitutes a problem since the flow bypassing the filtration module 26 by flowing in the gap 38 will essentially constitute a loss and will require an unnecessary amount of fluid feed (not shown) to be pumped thru the filtration module 26. Also, the membrane filtration elements 12 may loosen during operation which may result in buckling or wrinkling of the membrane filtration elements 12, which in turn may result in damage to the membrane filtration elements 12 and possibly leakage.

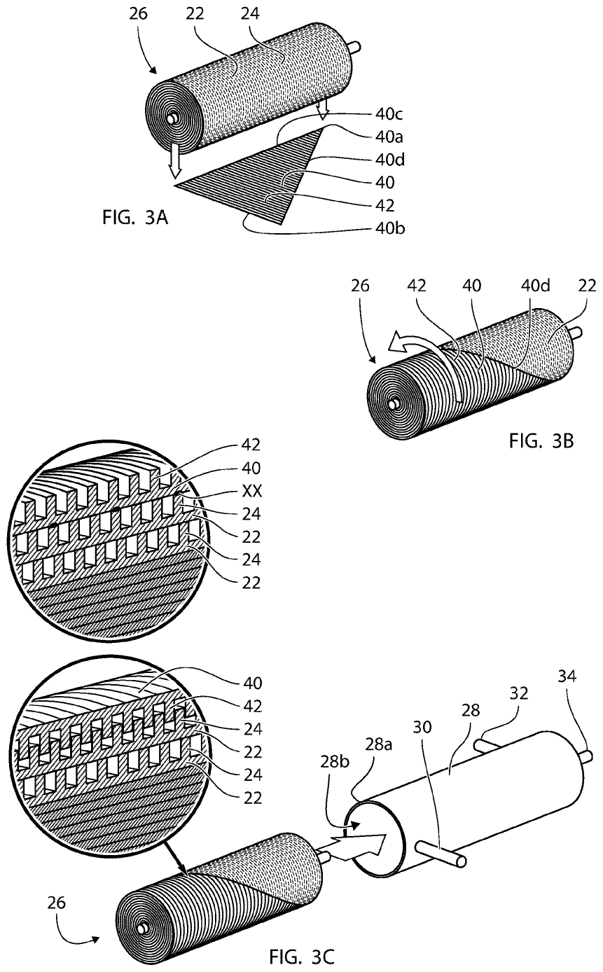

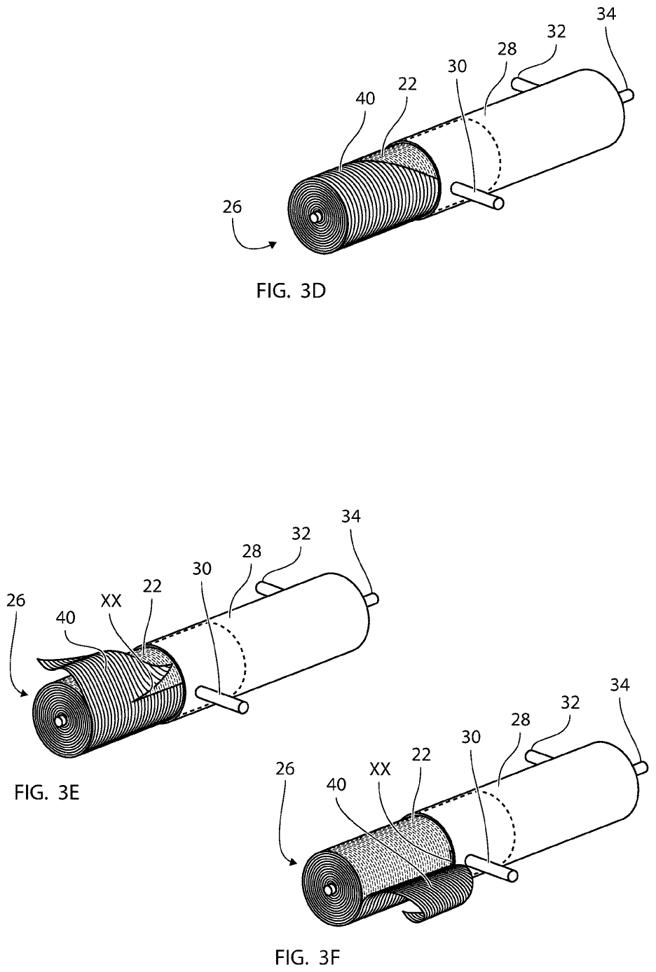

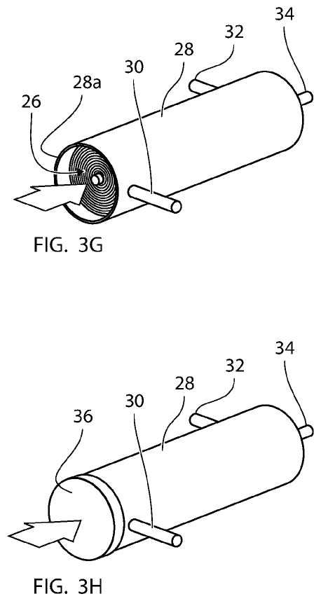

FIG. 3A is a perspective view of the filtration module 26 including a tapered flap 40. The tapered flap 40 defines a first edge 40a extending in the circumferential direction at a first end of the filtration module 26, a second edge 40b extending in the circumferential direction at a second end of the filtration module 26 and being longer than the first edge 40a, a third edge 40c extending between the first edge 40a and the second edge 40b along a straight longitudinal direction of the filtration module 26 and a fourth edge 40d extending between the first edge 40a and the second edge 40b opposite the third edge 40c and defining an angle relative to the longitudinal direction. The flap 40 is made of a fluid permeable polymeric grid material having ribs 42 extending in the circumferential direction similar to the wrap 22.

FIG. 3B is a perspective view of the filtration module 26 with the tapered flap 40 positioned onto the wrap 22. The flap 40 covers less than one turn around the wrap 22. The flap 40 is either provided as a separate part or may be fixated, i.e. welded or glued, onto the wrap 22. The tapering of the flap 40 will cause the perimeter of the filtration module 26 to increase along the longitudinal direction from the first edge 40a to the second edge 40b.

FIG. 3C is a perspective view of the insertion of the filtration module 26 including the flap 40 into the inner space 28b of the filter housing 28 via the opening 28′. The upper zoomed part shows the ribs 42 of the flap 40 and the ribs 24 of the wrap 22 facing in the same direction the flap 40 and the wrap 22 being fastened together by spot welds 44 The lower zoomed part show the ribs 42 of the flap 40 and the ribs 24 of the wrap 22 facing each other and interlocking to prevent slipping between the flap 40 and the wrap 22 when the filtration module 26 is being inserted into the filter housing 28.

FIG. 3D is a perspective view of the filtration module 26 partially inserted into the filter housing 28. As the perimeter of the filtration module 26 increases along the longitudinal direction, the gap between the opening 28a and the filtration module 26 will decrease the more of the filtration module 26 is inserted into the housing 28. By sliding the filtration module 26 into the inner space 28b of the housing 28 until the filtration module 26 stops due to not fitting into the housing 28, an indication is given of the width of the flap 30 needed to be cut away. This indication is the location where the opening 28a and the third edge 40c of the flap 40 intersects when the perimeter of the filtration module 26 exceeds the perimeter of the opening 28a.

FIG. 3E is a perspective view of the longitudinal cutting of the flap 40 at the location 46. By reducing the circumferential perimeter of the remaining part of the filtration module 26 by cutting the flap 40 at the location where the third edge 40c of the flap 40 meets the opening 28a it will be possible to insert the remaining part of the filtration module 26 into the housing 28 and achieve a snug fit without any use of trial and error, and without the risk of cutting too much off the flap 40.

FIG. 3F is a perspective view of the circumferential cutting of the flap 40 at the location 48. Cutting the flap 40 along the circumferential direction removes more of the flap 40 and may thus be less efficient compared to cutting in the longitudinal direction, however, by cutting the flap 40 along the circumferential direction it is not necessary to cut thru the ribs 42 which allows an easier cut. It may even be possible to tear the flap 40 by hand without using any tools such as a knife (not shown) or scissors (not shown).

FIG. 3G is a perspective view of the filtration module 26 fully inserted into the filter housing 28. The gap will essentially be eliminated for a large part of the filtration module 26, reducing many of the problems described above.

FIG. 3H is a perspective view of the filter housing 28 being closed by applying the lid 36. The filter housing 28 is now ready for operation. Removal of the filtration module 26 is made by removing the lid 36 and pulling out the filtration module 26.

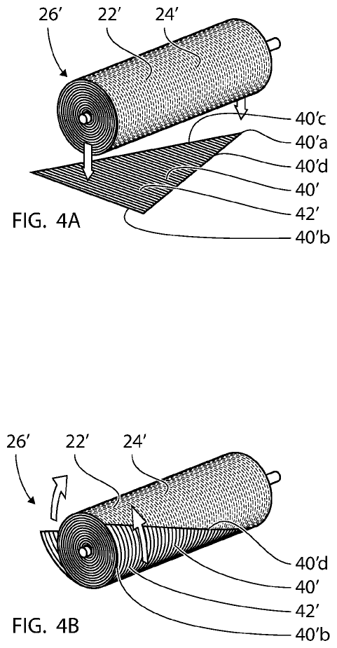

FIG. 4A is a perspective view of an alternative embodiment of the filtration module 26′ being similar to the previous embodiment except that it is including a variant of the tapered flap 40′. The flap 40′ defines a first edge 40′a extending in the circumferential direction at a first end of the filtration module 26′, a second edge 40′b extending in the circumferential direction at a second end of the filtration module 26′ and being longer than the first edge 40′a, a third edge 40′c extending between the first edge 40′a and the second edge 40′b and defining an angle relative to the longitudinal direction of the filtration module 26′ and a fourth edge 40′d extending between the first edge 40′a and the second edge 40′b opposite the third edge 40′c and defining an angle relative to the longitudinal direction. The flap 40′ is made of a fluid permeable polymeric grid material having ribs extending in the circumferential direction similar to the wrap 22′.

FIG. 4B is a perspective view of the filtration module 26′ with the tapered flap 40′ positioned onto the wrap 22′. The flap 40′ covers less than one turn around the wrap 22′. The flap 40′ is either provided as a separate part or it may be fixated, e.g. welded or glued, onto the wrap 22′. The perimeter of the filtration module 26′ will therefore increase along the longitudinal direction. The installation of the filtration module 26′ is similar to the previous embodiment, except that two cuts of the flap 40′ will be made, one on each of the third edge 40′c and fourth edge 40′d.

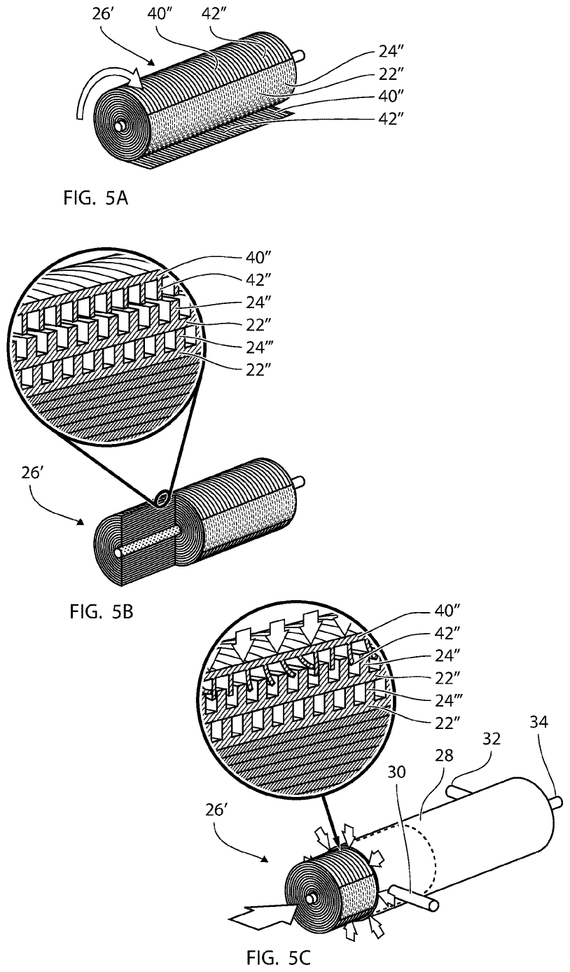

FIG. 5A is a perspective view of yet an alternative embodiment filtration module 26″ being similar to the previous embodiments except that the flap 40″ has straight edges, is flexible/elastic and having ribs 42″ defining a different spacing between themselves than the ribs 24″ of the wrap 22″. The flap 40″ covers less than one turn around the wrap 22″ FIG. 5B is a perspective view of the filtration module 26″ including the flexible flap 40″ positioned on the wrap 22″. The flap 40″ is preferably fixated onto the wrap 22″, e.g. by welding or gluing. As seen in the closeup, the ribs of the flap 40″ are facing the ribs of the wrap 22″.

FIG. 5C is a perspective view of the filtration module 26″ including the flap 40″ inserted into the filter housing 28. The flap 40″ can adapt to variety of perimeters of the interior space of the housing 28 to obtain a snug fit. This is achieved by the different spacing between the ribs 42″ of the flap 40″ and the ribs 24″ of the wrap 22″ allowing some ribs 42″ of the flap 40″ overlap/interfere with some ribs 24″ of the wrap 22″ which provides additional flexibility between the flap 40″ and the wrap 22″. This allows the filtration module 26″ to adapt to the manufacturing tolerances of the filter housing 28 and the filtration module 26″ and help achieving a snug fit between the housing 28 and the filtration module 26″ while allowing a very simple installation procedure as no cutting or other adaptations of the flap 40″ will be required at the time of installation.

1. A filtration module for filtrating a fluid feed into a retentate portion and a permeate portion, the filtration module being substantially cylindrical and extending in a longitudinal direction between a first end and a second end, the first end and the second end being substantially circular, the filtration module comprising:
a permeate tube extending substantially between the first end and the second end, the permeate tube defining a plurality of perforations,
a membrane filtration element extending substantially between the first end and the second end and being spirally wound around the permeate tube, the membrane filtration element being in fluid communication with at least one of the perforations,
a wrap surrounding the wound membrane filtration element and extending substantially between the first end and the second end, the wrap defining an outer surface, the outer surface defining a circumferential direction being substantially perpendicular to the longitudinal direction, and
a flap for being positioned onto and covering at least a part of the outer surface of the wrap, the wrap and the flap both being made of a fluid permeable polymeric grid material having ribs extending in the circumferential direction,
wherein the flap tapers in the longitudinal direction from the second end to the first end.

2. The filtration module according to claim 1, wherein the ribs of the wrap define a first spacing between themselves and the ribs of the flap define a second spacing between themselves, the first spacing being different than the second spacing.

3. The filtration module according to claim 1, wherein the ribs of the wrap and the ribs of the flap are facing each other, or alternatively, wherein the ribs of the wrap and the ribs of the flap are facing in the same direction.

4. A filtration module for filtrating a fluid feed into a retentate portion and a permeate portion, the filtration module being substantially cylindrical and extending in a longitudinal direction between a first end and a second end, the first end and the second end being substantially circular, the filtration module comprising:
a permeate tube extending substantially between the first end and the second end, the permeate tube defining a plurality of perforations,
a membrane filtration element extending substantially between the first end and the second end and being spirally wound around the permeate tube, the membrane filtration element being in fluid communication with at least one of the perforations,
a wrap surrounding the wound membrane filtration element and extending substantially between the first end and the second end, the wrap defining an outer surface, the outer surface defining a circumferential direction being substantially perpendicular to the longitudinal direction, and
a flap for being positioned onto and covering at least a part of the outer surface of the wrap, the wrap and the flap both being made of a fluid permeable polymeric grid material having ribs extending in the circumferential direction, wherein the ribs of the wrap define a first spacing between themselves and the ribs of the flap define a second spacing between themselves, the first spacing being different than the second spacing, the ribs of the wrap and the ribs of the flap are facing each other.

5. The filtration module according claim 4, wherein the flap tapers in the longitudinal direction from the second end to the first end.

6. The filtration module according to claim 4, wherein the flap defines a first edge extending in the circumferential direction at the first end, a second edge extending in the circumferential direction at the second end and being longer than the first edge, and a third edge extending between the first edge and the second edge at an angle relative to the longitudinal direction.

7. The filtration module according to claim 6, wherein the flap defines a fourth edge extending between the first edge and the second edge opposite the third edge and defining an angle relative to the longitudinal direction.

8. The filtration module according to claim 4, wherein the flap is fixated to the wrap by e.g. gluing or welding.

9. The filtration module according to claim 4, wherein the flap defines a higher flexibility than the wrap.

10. The filtration module according to claim 4, wherein the flap defines a higher elasticity than the wrap.

11. The filtration module according to claim 4, wherein the membrane filtration element comprises one or more permeate transfer sheets, one or more membrane sheets and one or more feed spacer sheets.

12. The filtration module according to claim 4, wherein the flap extending less than one turn in the circumferential direction along the outer surface, preferably between 20% and 80% of one turn in the circumferential direction along the outer surface, more preferably between 30% and 70% of one turn in the circumferential direction along the outer surface.

13. The filtration module according to claim 4, wherein the flap has a length in the longitudinal direction being equal or less than the distance between the first end and the second end, preferably between 20% and 80% of the distance between the first end and the second end, more preferably between 30% and 70% of the distance between the first end and the second end.

14. A method of installing a filtration module into a non-permeable filter housing, the filter housing defining an opening and an inner space being accessible thru the opening, the opening defining a first perimeter, the method comprising:
providing the filtration module according to claim 4, the filtration module defining a second perimeter,
inserting the first end of the filtration module into the opening of the housing and
sliding the filtration module into the inner space of the housing until the second perimeter exceeds the first perimeter, thereby leaving a remaining part of the filtration module outside the housing,
reducing the second perimeter of the remaining part of the filtration module by cutting the flap at the location where the flap meets the opening, and
inserting the remaining part of the filtration module into the housing.

15. The method according to claim 14, wherein the flap is cut in the circumferential direction.

16. The method according to claim 14, wherein the flap is cut in the longitudinal direction.

17. A method of installing a filtration module into a non-permeable filter housing, the filter housing defining an opening and an inner space being accessible thru the opening, the opening defining a first perimeter, the method comprising:
providing the filtration module according to claim 4, the filtration module defining a second perimeter,
inserting the first end of the filtration module into the opening of the housing, and
sliding the filtration module into the inner space of the housing, thereby reducing the second perimeter to match the first perimeter by causing the ribs of the wrap to interfere with the ribs of the flap.

18. The filtration module according to claim 2, wherein the ribs of the wrap and the ribs of the flap are facing each other, or alternatively, wherein the ribs of the wrap and the ribs of the flap are facing in the same direction.

19. The filtration module according to claim 5, wherein the flap defines a first edge extending in the circumferential direction at the first end, a second edge extending in the circumferential direction at the second end and being longer than the first edge, and a third edge extending between the first edge and the second edge at an angle relative to the longitudinal direction.

20. The filtration module according to claim 5, wherein the flap is fixated to the wrap by e.g. gluing or welding.
